(19) United States
(12) Patent Application Publication
(10) Pub. No.: US 2018/0178521 A1
(43) Pub. Date: Jun. 28, 2018

(54) METHOD TO ACTIVATE A PRINTING ELEMENT OF AN INKJET PRINTER

(71) Applicant: Océ Holding B.V., Venlo (NL)

(72) Inventors: Alexander Kreiter, Woerth (DE); Christian Maier, Feldkirchen-Westerham (DE); Wolfgang Hettler, Feldkirchen-Westerham (DE)

(73) Assignee: Océ Holding B.V., Venlo (NL)

(21) Appl. No.: 15/850,830

(22) Filed: Dec. 21, 2017

(30) Foreign Application Priority Data
Dec. 22, 2016 (DE) 10 2016 125 308.1

(51) Int. Cl. B41J 2/165; B41J 2/045

(52) U.S. Cl. CPC B41J 2/16517; B41J 2/04573; B41J 2002/14459; B41J 2/04596; B41J 2/04581

(57) ABSTRACT

A method to activate a printing element of an inkjet printer can include determining print data that indicates the usable print image to be printed with image point(s). The image point(s) are arranged at matrix point(s) of a print matrix. The method can also include determining virtual refresh data that indicates a virtual refresh image with refresh dots positioned at the matrix points based on a random algorithm, and activating the first printing element based on the virtual refresh data and the print data for the first column of the print matrix. The first printing element can be activated at a matrix point of the first column with: an ejection waveform to eject an ink droplet if the print data indicates an image point; and a vibration waveform to vibrate an ink meniscus of the first printing element without ink ejection if the virtual refresh data indicates a refresh dot.

### CROSS REFERENCE TO RELATED APPLICATIONS

This patent application claims priority to German Patent Application No. 102016125308.1, filed Dec. 22, 2016, which is incorporated herein by reference in its entirety.

### BACKGROUND

The disclosure relates to a method to activate printing elements of an inkjet printer, including an activation to prevent or reduce ink in the printing elements of the printer from drying out.

DE 10 2014 106 424 A1 describes an inkjet printer for single-color or multicolor printing to a recording medium. For example, a printer can have at least one print group with at least one print bar per print color. The print bar is arranged transversal to the transport direction of the recording medium and typically has multiple print heads that include a plurality of printing elements having nozzles in order to eject ink droplets from said nozzles. To print a row transversal to the printing direction, each nozzle is associated with a different image point of the row. In the longitudinal direction, the nozzles print the ink droplets onto the recording medium in chronological succession in order to print respective columns of a print image onto the recording medium. The higher the print resolution transversal to the transport direction, the more nozzles that are arranged in the print bars or the print heads.

During printing operation, it is desirable to maintain a particular viscosity (or range of viscosities) of the ink within a printing unit. If the viscosity increases too much, there is the danger of the ink drying out, which can cause the nozzle of the printing unit to at least partially clog. In this example, an ink droplet can no longer be cleanly ejected and/or its desired ejection direction is altered due to hindering ink residues, which can cause the droplet to strike at a position on the recording medium that diverges from the desired position.

U.S. Pat. No. 5,659,342 A describes an inkjet printer in which the danger of too stark an increase of the viscosity of the ink in the printing units of an inkjet printer is resolved via refresh droplets (“random dots” or “refresh dots”) that are printed in the image background during the printing operation. The ejection of refresh droplets leads to the situation that, even given a longer period without ejection of an ink droplet, the ink in the ink channel of the printing units is still renewed. Fresh ink is thereby still supplied to the print head from the ink reservoir, and the danger of the drying of the ink at the nozzle output of a printing unit is reduced. On the other hand, the refresh dots may be perceived by an observer as a disturbing, visible background of a print image. Furthermore, refresh dots may not be printed in some situations, for example, a printing pause, such that the increase of the viscosity of the ink in such special situations cannot be reliably suppressed.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates an ink print group of an inkjet printer according to an exemplary embodiment of the present disclosure.

FIG. 2 illustrates a cross-sectional presentation of a printing element of a print group according to an exemplary embodiment of the present disclosure.

FIG. 3 illustrates an example of a superposition of a usable print image and of a refresh print image according to an exemplary embodiment of the present disclosure.

FIG. 4 illustrates a print matrix to activate the printing element(s) of a print group according to an exemplary embodiment of the present disclosure.

FIG. 5 illustrates a flowchart of a method to activate a printing element of an inkjet printer according to an exemplary embodiment of the present disclosure.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

The present disclosure is directed to methods (and printers) via which the viscosity of the ink in a print head may be reliably and resource-efficiently kept at a low level while providing a high print quality.

According to an aspect of the present disclosure, a method to activate a first printing element of an inkjet printer is described, for example, to print a first column of a usable print image on a recording medium. The method can include the determination of print data that indicate the usable print image to be printed with one or more image points to be inked. The one or more image points are thereby arranged at one or more corresponding matrix points of a print matrix, wherein the print matrix comprises a plurality of rows and a plurality of columns. The method can also include the determination of virtual refresh data that indicate a virtual refresh image with refresh dots. The refresh dots can be positioned at the matrix points of the print matrix according to a random algorithm. The method can also include the activation of the first printing element depending on the virtual refresh data and depending on the print data for the first column of the print matrix. At a matrix point of the first column of the print matrix, the first printing element is activated with an ejection waveform to eject an ink droplet if the print data indicate an image point. Alternatively or additionally, at a matrix point of the first column of the print matrix, the first printing element is activated without ink ejection via a vibration waveform to vibrate the ink meniscus of the first printing element if the virtual refresh data indicate a refresh dot.

In one or more exemplary embodiments, the printing elements of an inkjet printer are controlled to reduce or prevent ink from drying out in a resource-efficient manner and with a high print quality.

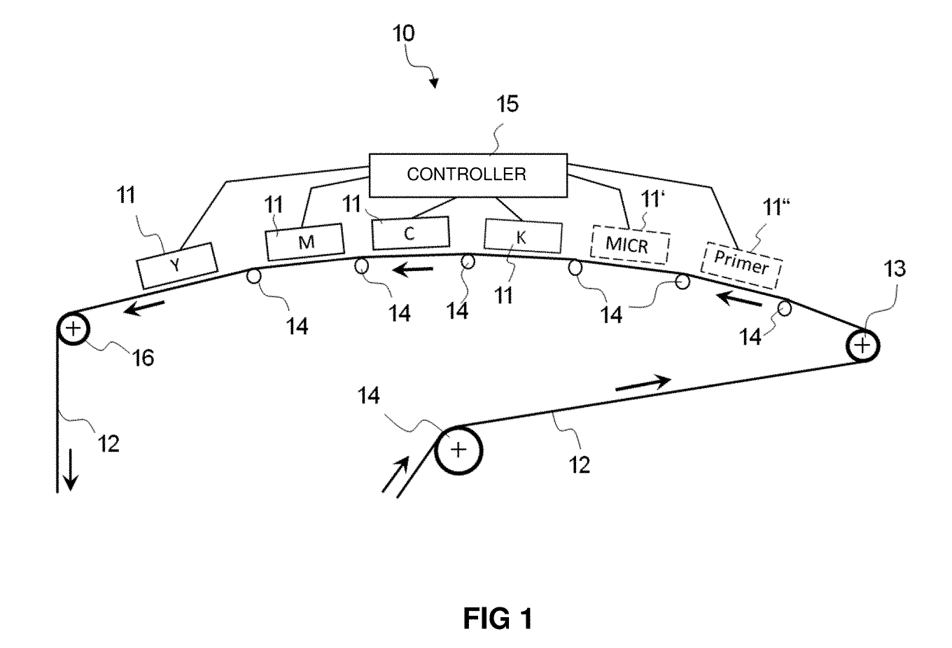

FIG. 1 illustrates a print group 10 of an inkjet printer according to an exemplary embodiment. The print group 10 can include at least one print bar 11 per color, where the print bar 11 includes one or more print heads that are arranged transversal to the transport direction (represented by corresponding arrows in FIG. 1) of a recording medium 12. Via printing elements of the one or more print heads, the recording medium 12 may be printed to row by row with the desired fluids, in particular with ink. In an exemplary embodiment, the print group 10 is configured as described in DE 10 2014 106 424 A1 and/or U.S. Pat. No. 9,302,474 B2, each of which is incorporated herein by reference in their entirety.

For color printing, print bars 11 for four primary colors can be used, namely YMCK (yellow=Y, magenta=M, cyan=C and black=K) or RBY (red, blue, yellow, as well as black). Moreover, one or more print bars 11′ may also be present for additional specific colors or special inks, for example Magnetic Ink Character Recognition (MICR) ink (e.g. magnetically readable ink). It is likewise possible that transparent special fluids, such as primer or drying promoters, are applied digitally with a separate print bar 11″ before or after the printing of a print image in order to improve the print quality and/or the adhesion of the ink on the recording medium 12.

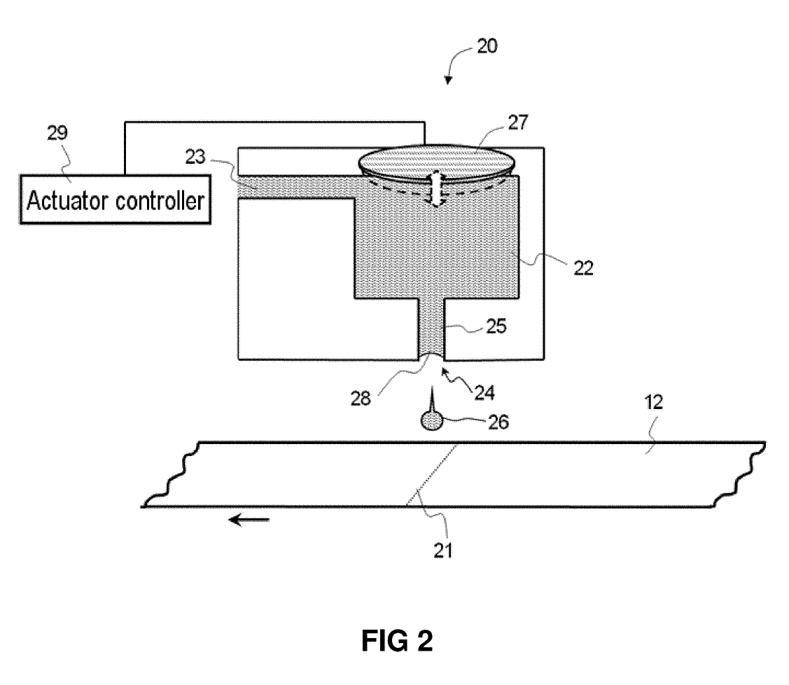

Each fluid or ink is printed with at least one print bar 11, 11′ or 11″. A row width may thereby be printed with one print bar 11. At least one printing element 20 is provided (see FIG. 2) for each print position (also designated as an image point, pixel or dot) within a print row 21. Depending on the desired resolution and print width, a corresponding amount of printing elements 20 are then included/defined as a print row 21.

A web-shaped recording medium 12 is directed (e.g. via an intake roller 13 and multiple deflection rollers 14) below and past the print bars 11 having the printing elements 20. Via a print head controller 15, the individual printing elements 20 are activated according to the print data with control signals in order to eject ink droplets 26 at corresponding image positions of the recording medium 12. In an exemplary embodiment, the print head controller 15 includes processor circuitry that is configured to perform one or more operations and/or functions of the print head controller 15, including, for example, activating the printing elements 20 (including one or more corresponding actuators).

In operation, the recording medium 12 is directed with a predetermined and possibly controllable web tension through the print group 10 so that the individual ink droplets 26 may respectively be printed exactly at the desired print position on the recording medium 12. With an outfeed roller 16, the recording medium 12 is further directed to a dryer (not shown), and possibly to a subsequent print group 10 in which the back side of the recording medium 12 may then be printed to.

An exemplary embodiment of a printing element 20 of a print head is depicted in FIG. 2. In an exemplary embodiment, the printing element 20 includes an ink chamber 22 that is filled or refilled with ink via an ink supply 23. A droplet 26 may be ejected via a nozzle 24 having a nozzle channel 25. An actuator 27 is arranged in the ink chamber 22 or in the nozzle channel 25 and is configured to generate a droplet 26. The actuator 27 is activated by an actuator controller 29, and configured to place the ink in the ink chamber 22 under mechanical pressure, whereby ink is expressed from the nozzle 24. The actuator controller 29 can be configured to activate the actuator 27 based on the print data.

In an exemplary embodiment, the actuator 27 is a piezoelement. In this example, the piezoelement is configured to expand (see double arrow and dashed line in FIG. 2) as it is activated accordingly, and thereby place the ink under pressure so that the ink may “escape” (e.g. be ejected) via the nozzle 24. In another embodiment, the actuator 27 is a thermal actuator. In this example, the thermal actuator (e.g. heating element) is configured to generate (e.g. explosively generate) a vapor bubble in the nozzle channel 25 via heat, which thereby presses an ink droplet 26 from the nozzle 24 via the pressure of the vapor bubble.

In an exemplary embodiment, the actuator controller 29 is configured to generate a control signal that controls/activates the actuator 27. The control signal can be a waveform that causes the actuator 27 to temporarily expand and contract again, possibly repeatedly. Via this changing application of negative pressure/positive pressure on the ink, the ink is set into oscillation, as a result of which droplets 26 may be expressed from the nozzle 24. Depending on the waveform (for example depending on frequency, amplitude, rise or fall time of a pulse, pulse/pause ratio given multiple pulses etc.), the droplets 26 may be ejected in different sizes or speeds from the nozzle 24. Given a relatively small amplitude, at a relatively high frequency of the oscillations of the waveform, and/or given relatively short pulses, only a vibration of the ink meniscus 28 may possibly be generated at the output of the nozzle channel 25, without an ink droplet 26 being released. Via different characteristics or properties of the waveform, differently formed droplets 26 and/or vibrations of the ink meniscus 28 may thus be produced at the output of the nozzle channel 25. A waveform via which an ink ejection is produced may be designated as an ejection waveform, and a waveform via which only a vibration of the ink meniscus 28 is produced without ink ejection may be designated as a vibration waveform. In an exemplary embodiment, the actuator controller 29 includes processor circuitry that is configured to perform one or more operations and/or functions of the actuator controller 29, including, for example, generating one or more control/activation signals (e.g. ejection and/or vibration waveforms). In an exemplary embodiment, the actuator controller 29 and the print head controller 15 are implemented as a single controller. In an alternative embodiment, the actuator controller 29 and the print head controller 15 are implemented as separate controllers.

In an exemplary embodiment, the waveform with which the actuator 27 is activated affects the size and formation of an ink droplet 26. Different ink droplet sizes may be ejected depending on the characteristic of the waveform. Depending on the print data, droplets 26 with different volumes between, for example, 2 and 30 pl can be generated at high print quality in high-speed printers. In an exemplary embodiment, via a vibration waveform, only the ink meniscus 28 at the nozzle output is set into vibration without releasing (ejecting) a droplet 26. The ink in the nozzle channel 25 is thereby vibrated as well and mixes with fresh ink from the ink chamber 22. As a result of this, the viscosity of the ink at the nozzle output is reduced, such that the danger of drying out at the nozzle output is reduced.

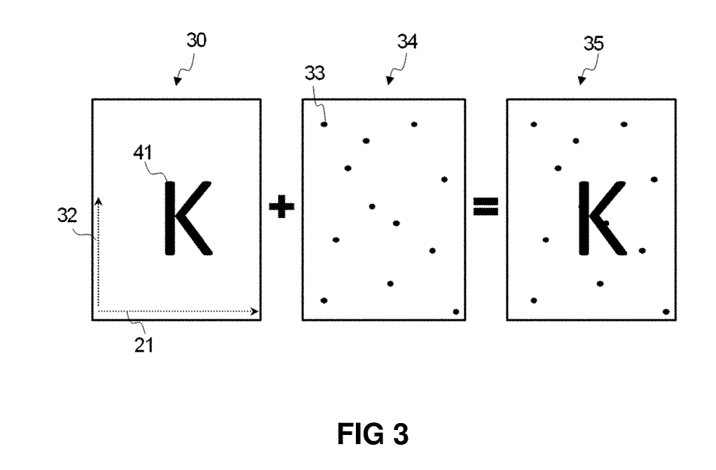

In printing operation, a usable print image 30 (see FIG. 3) is normally printed corresponding to the desired print data. The usable print image 30 is thereby printed row by row with the printing elements 20 of a print group 10. Via the individual printing elements, ink droplets 26 are ejected that are then applied as image points onto the recording medium 12.

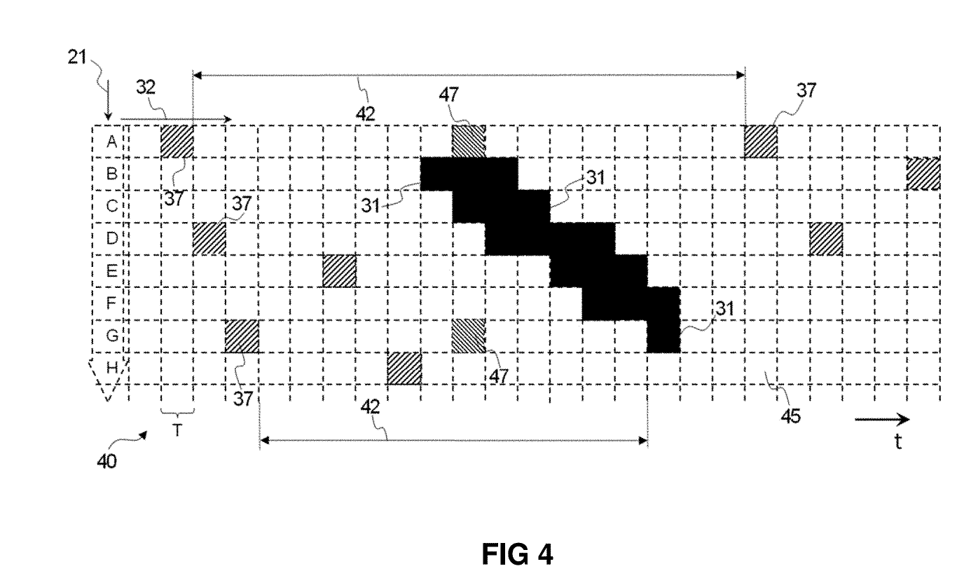

In an exemplary embodiment, a usable print image 30 is structured as a matrix, comprising n rows 21 and m columns 32 (see FIG. 4). Each column 32 is respectively printed by a different printing element 20. This occurs with a row clock given full-surface printing. A printing element 20 thus cannot print twice in a row 21, but rather may print once at most.

A usable print image 30 is typically not printed over its entire surface, but rather has a defined coverage density, meaning a specific proportion of the surface that is covered by image points of one color. This is also designated as a degree of areal coverage. The degree of areal coverage expresses the ratio of the printed area of a print image 30 to the total area of the print image 30 in a percentile. For example, the degree of areal coverage in documents with text and graphics is 5%, for instance. In such an instance, most printing elements 20 of a print group 10 are thus inactive for most of the time. In FIG. 3, the letter “K” is shown as an example of a usable print image 30 which is printed on an excerpt of the recording medium 12. For the printing of such a usable print image 30, the printing elements 20 of a print group 10 are inactive for a substantial proportion of the printing time.

If no droplet 26 is ejected from a nozzle 24 of a printing element 20 for a defined length of time, the danger exists that the ink in this nozzle 24 dries, and thus the viscosity of the ink is increased. The ejection behavior of a droplet 26 varies with the increase of the viscosity, up to the point of a complete sealing of the nozzle 24 with dried ink, which corresponds to a total failure of the nozzle 24. This is then perceptible in the print quality. The total failure of a nozzle 24 is visible in a usable print image 30, for example as light streaks in an area that is otherwise printed over the full area.

In an exemplary embodiment, to reduce the danger of the nozzles 24 of a print head 10 drying up, refresh dots may be printed in the background of a usable print image 30 according to a random algorithm. The printed refresh image points 33 (see FIG. 3) may be distributed randomly such that a refresh print image 34 results that, qualitatively, negatively affects the actual usable print image 30 as little as possible, meaning that it disturbs the optical impression of the print image 30 as little as possible. For this purpose, the sizes/volumes of the refresh dots and/or the total number of refresh dots per usable print image 30 may be adjusted, for example.

In an exemplary embodiment, the positions of the refresh image points 33 on the recording medium 12, the total number of refresh image points 33, and/or the droplet sizes or volumes of the refresh dots may depend on, for example, the condition of the ink (in particular with regard to the viscosity and drying behavior), the design of the print group 10, the embodiment of the print heads, the environmental conditions (e.g. temperature and/or humidity), and/or other factors as would be understood by one of ordinary skill in the art.

As depicted in FIG. 3, the final print image 35 may thus result from a superposition of the actual usable print image 30 and the refresh print image 34. Via the printing of the refresh image points 33, it should thereby be ensured that the duration between two successive activations of a printing element 20 does not lead to the ink drying out in the printing element 20. On the other hand, the ink consumption of a print group 10 is increased by the printing of the refresh image points 33. Furthermore, a refresh print image 34 may negatively affect the print quality of the final print image 35, in particular given a relatively high density of refresh image points 33.

In an exemplary embodiment, a virtual refresh image 34 with virtual refresh dots is “printed” as an alternative or in addition to the printing of a refresh print image 34 with randomly distributed refresh image points 33 to prevent the ink from drying out and to simultaneously enable a reduced ink consumption and/or a high print quality. A virtual refresh image may thereby be generated analogous to a refresh print image 34. In particular, a random distribution of virtual refresh dots—i.e. a refresh print image—may be generated for a usable print image 30 to be printed. A specific point density of the virtual refresh dots may thereby be established by a user.

In an exemplary embodiment, to “print” a virtual refresh dot, a printing element 20 is activated with a vibration waveform via which no ink ejection is produced although a vibration of the ink meniscus 28 of the nozzle 24 of the printing element 20 is produced. The refresh dots thus produce a reduction of the viscosity of the ink of a printing element 20 without thereby negatively affecting the print quality of a usable print image 30 to be printed.

In an exemplary embodiment, virtual, randomly distributed refresh dots that are not applied onto a recording medium 12 may thus be used in addition or as an alternative to real, printed refresh image points 33. In an exemplary embodiment, a refresh image is thereby generated according to the same algorithm as a refresh print image 34. However, an ejection pulse or an ejection waveform to generate an ink droplet 27 is absent given a refresh dot. Instead of ejection pulse/waveform, a vibration pulse or a vibration waveform is triggered to set the ink meniscus 28 into vibration without thereby causing an ink ejection. Via the activation of printing elements 20 using vibration waveforms according to the algorithm for the generation of refresh image points 33, it may be produced that the ink in the printing elements 20 retains its viscosity to the greatest possible extent, and thus print image artifacts may be avoided.

In an exemplary embodiment, to nevertheless regularly exchange the ink in the printing elements 20, full-area regeneration print images—for example refresh lines, i.e. linear regeneration print images—may be printed as necessary between different usable print images 30.

In an exemplary embodiment, a virtual refresh print image may also be generated and “printed” in a special operating mode of a printer, for example, in ramp printing (e.g. the printing speed is continuously increased or decreased), given a relatively slow printing, or in a printing pause. In addition to the print clock or line clock that is derived directly from the transport velocity of the recording medium 12, the printing elements 20 may thereby be activated with a virtual clock. In an exemplary embodiment, the virtual clock may correspond to the print clock or the line clock that is generated given a standard or maximum process speed of the printer. The activation of the printing elements 20 to “print” the virtual refresh dots may then take place based on the virtual clock. It may thus be ensured that the printing elements 20 of a print group 10 are refreshed or regenerated similarly even in different operating modes.

In an exemplary embodiment, a printing element 20 is activated based on the print data to print image points of a usable print image 30. The activation on the basis of the print data may take place with the line clock, which depends on the transport velocity of the recording medium 12. For each image point of the usable print image 30, the print data indicate whether an ink droplet 26 should be ejected, and possibly the droplet size of the ink droplet 26 to be ejected. For each image point indicated in the print data, the activation of the printing elements 20 then takes place with an ejection waveform.

In an exemplary embodiment, the printing element 20 may be activated based on virtual refresh data, where the refresh data indicates a virtual refresh image. In an exemplary embodiment, the activation based on the virtual refresh data may take place with a virtual clock that may be independent of the transport velocity of the recording medium 12. For each point of a virtual refresh image, the virtual refresh data indicates whether the printing element 20 should be activated with a vibration waveform or not.

FIG. 4 illustrates a print matrix 40 with individual matrix points 45 according to an exemplary embodiment of the present disclosure. In an exemplary embodiment, the print matrix 40 includes a plurality of rows 21 that travel transversal to the transport direction of the recording medium 12, and a plurality of columns 32 (identified as A, B, C etc. in FIG. 4) that are arranged in the transport direction of the recording medium 12. In an exemplary embodiment, precisely one printing element 20 of a print bar 11 is associated with each column 32. In this example, a printing element 20 may thereby:

a) be activated precisely once with an ejection waveform to print an image point 31;

b) be activated precisely once with a vibration waveform to print a refresh dot 37; or

c) not be activated.

In an exemplary embodiment, for each matrix point 45, the print data and the virtual refresh data thereby include instructions for a corresponding printing element 20. The instructions indicated in the print data for the printing of an image point 31 thereby typically take priority over the instructions indicated in the virtual refresh data for the printing of a refresh dot 37.

As is illustrated in FIG. 4, it may be (in particular given use of a relatively low density of refresh dots 37) that the time interval 42 between two matrix points 45 at which a printing element 20 is activated exceeds a defined maximum duration. Upon exceeding the maximum duration, it may occur that the ink in a printing element 20 dries up. Such time intervals 42 may be identified based on the print data and the virtual refresh data.

In order to prevent the ink in an affected printing element 20 from drying out, in a time interval 43 that is too long, one or more matrix elements 45 may be used to induce the printing element 20 to perform a vibration cycle 47. In other words, between two chronologically successive activations of the same nozzle 24 a vibration cycle may be performed if the time interval 42 between the activations has reached or exceeded a defined maximum duration. The actuator 27 is thereby activated such that the ink meniscus 28 at the nozzle output is placed in vibration without thereby ejecting a droplet 26. In vibration, the surface of the ink at the nozzle output alternatively curves outward (convex) and inward (concave) in a rhythm determined by the waveform and the movement of the actuator 27. For example, a vibration cycle 47 may include the activation of a printing element 20 with a vibration waveform.

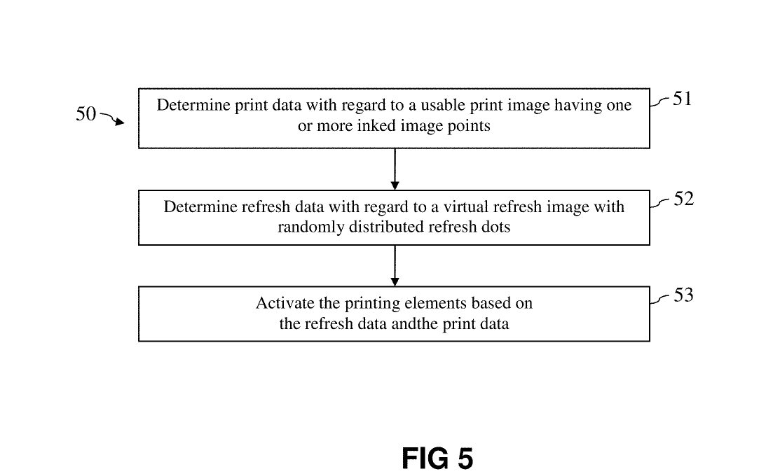

FIG. 5 shows a flowchart 50 of a method to activate a first printing element 20 of an inkjet printer according to an exemplary embodiment. In particular, the first printing element 20 may be activated in order to print a first column 32 of a usable print image 30 on a recording medium 12. The inkjet printer may thereby include a plurality of printing elements 20 for the corresponding plurality of columns 32 of a usable print image 30. The method 50 may be executed for each of a plurality of printing elements 20.

The recording medium 12 and the plurality of printing elements 20 may be moved relative to one another in a transport direction. For example, the recording medium 12 may be directed past the stationary printing elements 20. In one or more embodiments, the printing elements 20 move with respect to a stationary or moving recording medium. The plurality of columns 32 of a usable print image 30 may then travel along the transport direction, and the plurality of rows 21 of a usable print image 30 may travel transversal to the transport direction. Sequential rows 21 of the usable print image 30 may be printed onto the recording medium 12, transversal to the recording medium 12, via the plurality of printing elements 20. On the other hand, precisely one column 32 of the usable print image 30 may respectively be printed by one printing element 20 of the plurality of printing elements 20.

In an exemplary embodiment, the method 50 includes the determination 51 of print data that indicate the usable print image 30 to be printed with one or more image points 31 that are to be inked. The one or more image points 31 may thereby be arranged at one or more corresponding matrix points 45 of a print matrix 40, wherein the print matrix 40 comprises a plurality of rows 21 and a plurality of columns 32. In other words: the usable print image 30 may be rastered in a print matrix 40, and the print data may indicate whether a “non-white” image point 31 should be printed or not at a matrix point or raster point 45. Furthermore, the print data may possibly indicate a droplet size of an ink droplet 26 to be ejected.

In an exemplary embodiment, the method 50 also includes the determination 52 of virtual refresh data that indicate a virtual refresh image with refresh dots 32. The refresh dots 32 may also be designated as virtual “random dots”. The refresh dots 32 may be positioned at the matrix points 45 of the print matrix 40 according to a random algorithm. In other words: the refresh dots 32 may be positioned randomly within the print matrix 40. The random algorithm is thereby typically designed such that the refresh dots 32 are positioned independently of the print data for the usable print image 30.

Moreover, the method 50 can include the activation 53 of the first printing element 20 based on the virtual refresh data and/or the print data for the first column 32 of the print matrix 40. The print data and the virtual refresh data typically include activation instructions for the plurality of columns 32 of the print matrix 40, or for the plurality of corresponding printing elements 20. The activation instructions may, for example, include bit sequences (for example K bits per matrix point 45, with K>1) that indicate to the print head controller 15 whether and possibly with which waveform the actuator 27 of a printing element 20 should be activated at a respective matrix point 45.

At a matrix point 45 of the first column 32 of the print matrix 40, the first printing element 20 may be activated with an ejection waveform to eject an ink droplet 26 if the print data indicate an image point 31 for the matrix point 45. On the other hand, at a matrix point 43 of the first column 32 of the print matrix 40, the first printing element 20 may be activated with a vibration waveform to vibrate an ink meniscus 28 of the first printing element 20 without ink ejection if the virtual refresh data indicate a refresh dot 32 for the matrix point 45. The activation with an ejection waveform thereby typically has priority over the activation with a vibration waveform. In particular, the print data typically have priority over the virtual refresh data.

A method 50 for activation of a printing element 20 of an inkjet printer is thus described in which a usable print image 30 is superimposed with a virtual refresh image that has randomly arranged virtual refresh dots 47. The printing element 20 is thereby activated such that a vibration of the ink meniscus 28 of the printing element 20 takes place without ink ejection for the virtual refresh dots 47. A regeneration of the printing element 20, in particular a regeneration of the ink in the printing element 20, may thus take place with high print quality.

The method 50 may additionally include the determination, on the basis of the print data and on the basis of the virtual refresh data, of a time interval 42 between two successive activations of the first printing unit 20. The activations may thereby include an activation with an ejection waveform and/or with a vibration waveform. The first printing element 20 may then be activated with a vibration cycle 47 in the time interval 42 if the time interval 42 exceeds a predefined maximum duration. The maximum duration may thereby depend on, for example, the drying properties of the ink being used. During the vibration cycle 47, the ink meniscus 28 of the first printing element 20 is then moved without ink ejection. The regeneration of the first printing unit 20 may thus be further improved. In particular, a particularly reliable regeneration of a printing element 20 may be produced via the combined use of print data-dependent ejection waveforms, randomly generated vibration waveforms, and rest time-dependent vibration cycles, without thereby producing an overheating of the printing element 20 due to too frequent activation.

The determination 52 of virtual refresh data may include the determination of an information set with regard to a density and/or a count of refresh dots 32 within the virtual refresh image. For example, the information set maybe provided by a user of the inkjet printer. The virtual refresh data may then be determined depending on the information set. The regeneration of the printing elements 20 of an inkjet printer may thus be flexibly adapted, for example to a specific ink type.

In an exemplary embodiment, the method 50 can include the determination of a line clock and a virtual clock. The line clock and the virtual clock may thereby be different. In an exemplary embodiment, the line clock is dependent on the transport velocity of the recording medium 12 with which the first printing element 20 and the recording medium 12 move relative to one another. In particular, the line clock may be proportional to the transport velocity in order to precisely time the printing of the rows 21 of the usable print image 30. In an exemplary embodiment, on the other hand, the virtual clock is independent of the transport velocity. For example, the virtual clock may be dependent on a timer (e.g. an oscillator).

In an exemplary embodiment, with regard to the print data, the first printing element 20 may then be activated depending on the line clock, and with regard to the virtual refresh data may be activated depending on the virtual clock. An activation of the first printing element 20 may thus take place according to the virtual refresh data, which is independent of the transport velocity and/or independent of an operating mode of the inkjet printer. For example, a regeneration of the first printing element 20 may thus take place even at a relatively low transport velocity or during a printing pause.

In an exemplary embodiment, the virtual clock may be N times the line clock if the line clock is greater than 0 (e.g. given a relatively low transport velocity). N is thereby a whole number, with N≥1. The virtual refresh data may then have a resolution of refresh dots 37 along the first column 32 that is N times greater than the resolution of image points 31 of the print data. An efficient superposition of the usable print data and the virtual refresh data may thus take place. Furthermore, a reliable regeneration of the first printing element 20 is enabled via the N-tuple clocking of the virtual refresh data, even given relatively low transport velocities.

In an exemplary embodiment, the first printing element 20 has a maximum activation frequency with which the first printing element 20 may be activated. In an exemplary embodiment, the virtual clock is less than or equal to the maximum activation frequency. It may thus be ensured that the first printing element 20 may be reliably activated on the basis of the virtual refresh data.

In an exemplary embodiment, the method 50 can include a determination of actual refresh data that indicates an actual refresh print image 34 with printed refresh image points 33. The printed refresh image points 33 may thereby also be positioned at the matrix points 45 of the print matrix 40 according to a random algorithm. The first printing element 20 may then also be activated depending on the actual refresh data. In particular, the first printing element 20 may be activated at a matrix point 45 of the first column 32 of the print matrix 40 with an ejection waveform for the ejection of an ink droplet 26 if the actual refresh data indicate a printed refresh image point 33 for the matrix point 45. Randomly distributed, inked printed refresh image points 33 may thus be printed onto the recording medium 12, possibly in addition to the randomly distributed virtual refresh dots 37. A relatively small amount of printed refresh image points 33 may thereby typically be printed, such that no substantial negative effect on the final print image 35 occurs although an improved regeneration of the printing elements 20 occurs.

In an exemplary embodiment, an inkjet printer is configured to execute one or more embodiments of the method 50.

In an exemplary embodiment, the print quality of an inkjet printer may be increased via the use of virtual refresh dots 37 instead of or in addition to actually printed refresh image points 33; in particular, a white background may be maintained, if applicable. Furthermore, the width of regeneration print images may be reduced. In total, the ink consumption may thus be reduced.

In an exemplary embodiment, the density of refresh dots 37 may be flexibly adapted. Furthermore, it may be enabled for a user to flexibly select between the printing of refresh image points 33 and the use of virtual refresh dots 37. Furthermore, a combination of virtual refresh dots 37 and actual printed refresh image points 33 may be enabled in an embodiment. An inkjet printer may thus be adapted to different ink types and/or different print quality requirements.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, “processor circuitry” can include one or more circuits, one or more processors, logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. In one or more exemplary embodiments, the processor can include a memory, and the processor can be “hard-coded” with instructions to perform corresponding function(s) according to embodiments described herein. In these examples, the hard-coded instructions can be stored on the memory. Alternatively or additionally, the processor can access an internal and/or external memory to retrieve instructions stored in the internal and/or external memory, which when executed by the processor, perform the corresponding function(s) associated with the processor, and/or one or more functions and/or operations related to the operation of a component having the processor included therein.

In one or more of the exemplary embodiments described herein, the memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

### REFERENCE LIST

10 print group (print head)
11 print bar
12 recording medium
13 intake roller
14 deflection roller
15 print head controller
16 outfeed roller
20 printing element
21 print line
22 ink chamber
23 ink supply
24 nozzle
25 nozzle channel
26 ink droplet
27 actuator
28 ink meniscus
29 actuator controller
30 usable print image
31 image point
32 column
33 refresh image point
34 refresh print image
35 final print image
37 refresh dot
40 print matrix
42 time interval
45 matrix point
T line pitch

1. A method to activate a first printing element of an inkjet printer to print a first column of a usable print image on a recording medium, the method comprising:
determining print data that indicates the usable print image to be printed with one or more image points to be inked, the one or more image points being arranged at accordingly one or more matrix points of a print matrix including a plurality of rows and a plurality of columns;
determining virtual refresh data that indicates a virtual refresh image with refresh dots positioned at the matrix points of the print matrix based on a random algorithm; and
activating the first printing element based on the virtual refresh data and the print data for the first column of the print matrix, wherein the first printing element is activated at a matrix point of the first column of the print matrix with:
an ejection waveform to eject an ink droplet if the print data indicates an image point; and
a vibration waveform to vibrate an ink meniscus of the first printing element without ink ejection if the virtual refresh data indicates a refresh dot.

2. The method according to claim 1, wherein the activation with the ejection waveform has priority over the activation with the vibration waveform.

3. The method according to claim 1, wherein:
the method further comprises determining a time interval between two successive activations of the first printing unit based on the print data and the virtual refresh data;
the first printing element is activated with a vibration cycle in the time interval if the time interval exceeds a predefined maximum duration; and
the ink meniscus of the first printing element is moved without ink ejection during the vibration cycle.

4. The method according to claim 1, wherein the determination of the virtual refresh data comprises determining an information set with regard to a density and/or a number of refresh dots within the virtual refresh image, the virtual refresh data being determined based on the information set.

5. The method according to claim 1, further comprising: determining a line clock and a virtual clock, wherein the first printing element is activated based on the line clock with regard to the print data and the virtual clock with regard to the virtual refresh data.

6. The method according to claim 5, wherein:
the first printing element has a maximum activation frequency with which the first printing element may be activated; and
the virtual clock timing is less than or equal to the maximum activation frequency.

7. The method according to claim 5, wherein:
the line clock depends on a transport velocity of the recording medium with which the first printing element and the recording medium are moved relative to one another;
the virtual clock is N times the line clock if the line clock is greater than zero, N being a whole number and N≥1; and
the virtual refresh data have a resolution of refresh dots along the first column that is N times greater than a resolution of image points of the print data.

8. The method according to claim 6, wherein:
the first printing element has a maximum activation frequency with which the first printing element may be activated; and
the virtual clock timing is less than or equal to the maximum activation frequency.

9. The method according to claim 1, wherein the random algorithm is configured to position the refresh dots independently of the print data in the print matrix.

10. The method according to claim 1, further comprising:
determining actual refresh data that indicates an actual printed refresh image with printed refresh dots being positioned at the matrix points of the print matrix according to the random algorithm, wherein:
the first printing element is further activated based on the actual refresh data; and
the first printing element is activated with the ejection waveform to eject the ink droplet at the matrix point of the first column of the print matrix if the actual refresh data indicates a printed refresh dot.

11. The method according to claim 1, wherein:
the inkjet printer comprises a plurality of printing elements corresponding to the plurality of columns;
the recording medium is directed in a transport direction past the plurality of printing elements;
the plurality of columns travel along the transport direction;
the plurality of rows travel transverse to the transport direction;
the plurality of printing elements are configured to print a row of the usable print image onto the recording medium transverse to the transport direction; and
a printing element of the plurality of printing elements is configured to print a single column of the usable print image.

12. A non-transitory computer-readable storage medium with an executable program stored thereon, wherein, when executed, the program instructs a processor to perform the method of claim 1.

13. An inkjet printer, comprising:
a printing element including an actuator and configured to print a first column of a usable print image on a recording medium; and
a controller communicatively coupled to the printing element and configured to:
determine print data indicative of the usable print image to be printed with one or more image points to be inked, the one or more image points being arranged at accordingly one or more matrix points of a print matrix including a plurality of rows and a plurality of columns;
determine virtual refresh data indicative of a virtual refresh image with refresh dots positioned at the matrix points of the print matrix based on a random algorithm;
generate an ejection waveform and a vibration waveform to activate the actuator of the printing element based on the virtual refresh data and the print data for the first column of the print matrix, the actuator being configured to be activated at a matrix point of the first column of the print matrix with:
the ejection waveform to eject an ink droplet in response to the print data indicating an image point; and
the vibration waveform to vibrate an ink meniscus of the printing element without ink ejection in response to the virtual refresh data indicating a refresh dot.
